(19) United States
(12) Patent Application Publication
(10) Pub. No.: US 2014/0108426 A1
(43) Pub. Date: Apr. 17, 2014

(54) INTERACTIVE SYSTEM FOR COLLECTING, DISPLAYING, AND RANKING ITEMS BASED ON QUANTITATIVE AND TEXTUAL INPUT FROM MULTIPLE PARTICIPANTS

(71) Applicant: THE REGENTS OF THE UNIVERSITY OF CALIFORNIA, Oakland, CA (US)

(72) Inventors: Kenneth Y. Goldberg, Mill Valley, CA (US); David Wong, Cupertino, CA (US); Ephrat Bitton, Pleasanton, CA (US); Siamak Faridani, Albany, CA (US)

(73) Assignee: THE REGENTS OF THE UNIVERSITY OF CALIFORNIA, Oakland, CA (US)

(21) Appl. No.: 14/046,816

(22) Filed: Oct. 4, 2013

Related U.S. Application Data
(63) Continuation of application No. PCT/US2012/031203, filed on Mar. 29, 2012.
(60) Provisional application No. 61/473,645, filed on Apr. 8, 2011.

(51) Int. Cl. G06F 17/30

(52) U.S. Cl. CPC G06F 17/3053
USPC 707/748; 707/756

(57) ABSTRACT

A system for interactive visualization of items in an online environment based on textual and quantitative properties of those items is described. End-users of the system are humans and items can be any objects such as songs, books, and other users. One aspect of the system is a process used to map an item's quantitative and textual data into a position in the visualization, e.g., a two or three dimensional space. Using transformation matrices canonical correlation analysis (CCA) and a specific item's quantitative and textual data, the system projects an item onto the visualization and uses ratings and spatial positions to assign reputation values to each end-user and their textual responses to facilitate efficient browsing and rating of items and viewing of patterns, trends, and insights as they emerge.

### CROSS-REFERENCE TO RELATED APPLICATIONS

This application is a 35 U.S.C. §111(a) continuation of PCT international application number PCT/US2012/031203 filed on Mar. 29, 2012, incorporated herein by reference in its entirety, which is a nonprovisional of U.S. provisional patent application Ser. No. 61/473,645 filed on Apr. 8, 2011, incorporated herein by reference in its entirety. Priority is claimed to each of the foregoing applications.

The above-referenced PCT international application was published as PCT International Publication No. WO 2012/138539 on Oct. 11, 2012 and republished on Dec. 27, 2012, which publications are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED IN A COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to social media and more particularly the present invention is designed to help human end-users generate and exchange ideas about issues, policies, products, or other topics of mutual interest.

2. Description of Related Art

Since 2000, the volume of interaction in social media has grown significantly. However, existing systems for online discussion such as linear lists do not scale well. The first problem with lists is that the amount of data presented to an end user can be overwhelming. For example, news stories and blog posts can generate hundreds or thousands of responses. Lists bias those responses at the top and make it unwieldy for end-users to navigate through responses. Furthermore, the linear list interface impedes perception and consideration of the diversity of responses.

### BRIEF SUMMARY OF THE INVENTION

The present invention provides for a spatial projection of items based on textual and quantitative properties of those items. Items can be any objects such as songs, books, textual responses, and other end-users. The system uses the textual and quantitative properties of an item to represent the item in a higher dimensional representation or space and then projects the item into a lower dimensional representation or space, e.g., a two or three-dimensional space.

In a preferred embodiment, the system uses canonical correlation analysis (CCA) to find transformation matrices given the quantitative and textual data. Using the transformation matrices and a specific item's quantitative and textual data, the system projects an item from a higher dimensional representation or space into a lower dimensional representation or space.

The invention includes reputation models that determine the numerical reputation of an item based on the ratings of that item from end users: a confidence interval reputation model and a spatial and reviewer reputation model.

In a preferred embodiment, the systems and method of the present invention incorporates a visual analog scale that allows end users to rate the items using a sliding scale rather than rating scales that only use binary or discrete values, e.g. thumbs up or down, and five-star Likert scales.

In one preferred embodiment, a confidence interval reputation model is used to rank items based on the lower bound of a 95% confidence interval of the mean ratings for that item. The ratings may also be transformed by the transformation function used in the spatial and reviewer reputation model described below. The distribution of the ratings in the system may not be normally distributed and can be multi-modal; it can be modeled, in a preferred embodiment, by a mixture of normal distributions and Bernoulli distributions. Accordingly, the specific parameters are inferred from the data before ranking items using this reputation model.

The spatial and reviewer reputation model of the present invention factors in the distance between the end-user and the item as well as a measure of how “well” the user has been at rating items, also known as the reviewer score. As the end user and items in the system are both projected using the same type of data, the distance between the end-user and an item reflects the difference in the data used for projection.

In one preferred embodiment, the items that an end-user can browse are other users. In another preferred embodiment, the items in the system are not other users, but are objects, such as books or songs. In this embodiment the system is used more like a search interface. The reputation model corrects for bias by scaling the ratings by the distance between the user and the item and by the user's reviewer score; it sums up the total scaled ratings to yield the reputation values.

Furthermore, in a preferred embodiment, the invention includes user-interface (UI) tools that allow users to indicate a region within the visualization for the system to return a desired set of recommended items. This differs from other recommendation systems that do not allow users to manipulate the visualization directly to indicate search regions graphically. In two preferred embodiments, the system can provide: 1) a “lasso” tool that can indicate free form search regions on the visualization, and 2) two concentric circles where the radii of the circles are adjustable to any magnitude, effectively forming a “donut” search region.

In one preferred embodiment of the invention, end-users themselves are the items in the system. End users use graphical sliders to express the degree to which they agree or disagree with five baseline statements such as: “I'm very interested in issue A,” or “I am an active user of product B.” These responses are combined to display the end-user as a unique point in a map. The map is not based on predetermined categories, but on similarity of interests, behavior, and perspectives. The map is configured to “depolarize” discussions by including all end-users on a single level playing field. End-users click on the points of other users to read ideas and suggestions on discussion topics such as “What new approaches could be used to address issue C? “What features would you like to see in a new version of product D?” End users evaluate the ideas of others and enter their own ideas. End users earn points as reviewers based on how they evaluate the ideas of others and earn points as authors based on how others rate their ideas.

An aspect of the invention is the method used to project items from a higher dimensional space to a lower dimensional space.

Another aspect of the invention is the reputation model within the system that assigns a numerical reputation to the items in the system.

A still further aspect of the invention is user-controlled recommendation using UI tools within a visualization system.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic representation in block form of the process by which textual data and quantitative data of all items in the system are fed into CCA to yield transformation matrices.

FIG. 2 is a schematic representation in block form of the process by which an item's textual data and quantitative data are combined with the transformation matrices to output an item's projection coordinates in its lower dimensional representation.

FIG. 3. is a schematic representation in block form of a spatial and reviewer reputation model that translates an item's rating values into a numerical reputation value.

FIG. 4. is a schematic representation in block form of the confidence interval reputation model that translates an item's rating values into a numerical reputation value.

FIG. 5. is a schematic representation in block form of a method for transforming an item's rating values using a spatial and reviewer transformation and then inputted into a confidence interval reputation model to generate an item reputation value.

FIG. 6 is a schematic view of a system in accordance with the present invention having a server communication with a database and with clients through the Internet.

FIG. 7 is an illustration of a preferred embodiment of the invention having a graphical user interface that serves as an interactive visualization system.

FIG. 8A is a plot of a non-normal distribution of ratings based on state department data.

FIG. 8B is a plot of a non-normal distribution of ratings based on automotive industry study data.

FIG. 9 is a diagram illustrating the transformation of raw ratings given the distance between a user and an item in the system.

FIG. 10 is an example of the concentric circle UI tool for selecting a region for recommendation in accordance with the invention.

FIG. 11 is an example of a polygonal search region for recommended items drawn using the lasso tool.

### DETAILED DESCRIPTION OF THE INVENTION

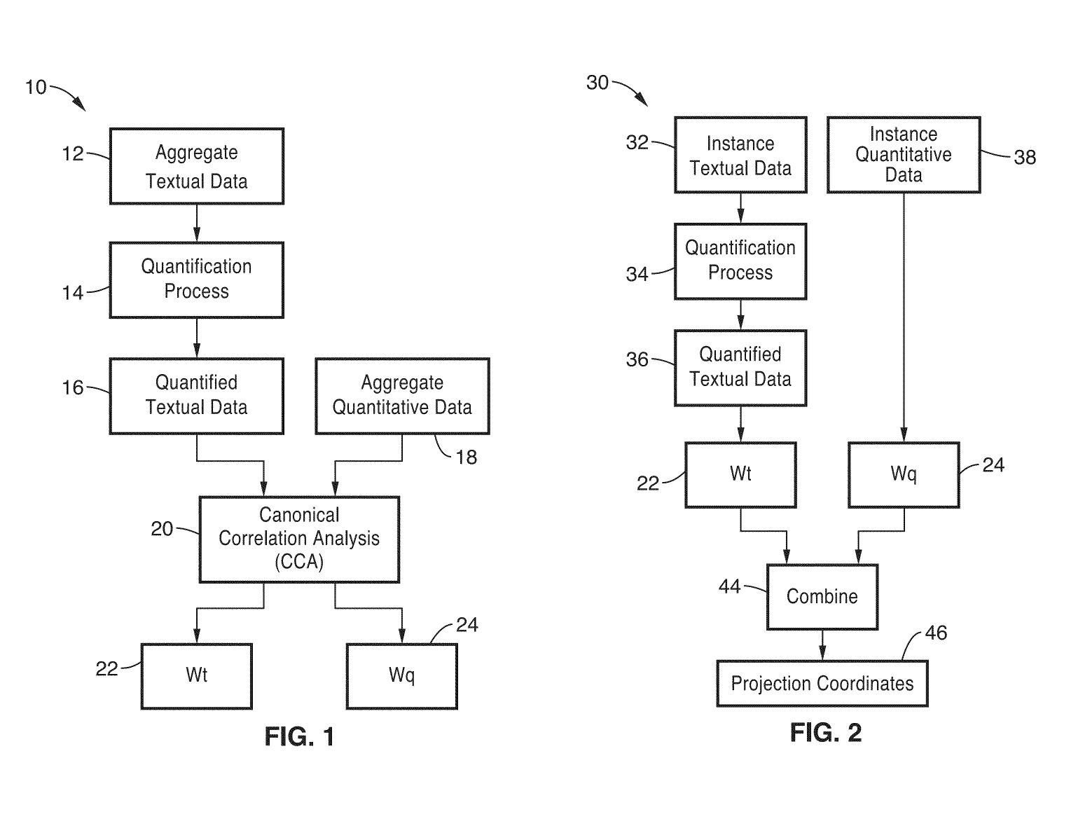

Referring first to a preferred embodiment of the present invention described in FIG. 1 and FIG. 2, a method is shown for projecting items from a higher dimensional representation to a lower dimensional representation or space.

FIG. 1 shows method 10 by which textual data and quantitative data of all items in the system (e.g. aggregate textual data and aggregate quantitative data) are fed into transformation function (e.g. canonical correlation analysis (CCA)) to yield transformation matrices.

At step 18, the method collects the aggregate quantitative data, e.g. data in the form of numerical ratings or all items and users in the system. For example, the aggregate quantitative data 18 may comprise a rating of a data item such as a statement “Company A acts responsibly toward the environment”. The rating might be on a scale from “strongly disagree” to “strongly agree” to convey how much an end-user agrees with the statement. The system can also collect or import quantitative data such as demographics of end-users (e.g. age or zip code) and other quantitative data such as times and Internet addresses. The item's quantitative data is in the form of an n-dimensional vector of values.

At step 16, the method 12 collects the aggregate textual data, such as names and email addresses entered into forms, import textual data such as addresses, and also collect typed textual responses to prompts for discussion such as “What is a specific way that Company A can improve its reputation among customers like you?”

At step 14 the aggregate textual data is converted into quantitative form through featurization, where features are extracted from the corpus of text and are used to transform each individual item's textual data into an n-dimensional vector of numbers. In a preferred embodiment, this featurization step 14 is performed using a bag-of-words approach to analyze the text. Alternatively, topic modeling algorithms Latent Dirichlet Allocation (LDA) and Hierarchical Dirichlet Processes-LDA (HDP-LDA) are used to select important keywords and topics from the text. In another preferred embodiment, term frequency inverse document frequency analysis (tf-idf) is used with Latent Semantic Indexing (LSI) to select important keywords from the text.

At step 20, values from quantitative data 18 and quantified text data 16 are used as input into a data projection algorithm, such as Canonical Correlation Analysis. While other data projection algorithms (e.g. (PCA) Principle Component Analysis) exist and may be implemented to some degree, CCA is a preferred data projection algorithm, as it is amenable to correlation of two disparate data sources. The use of CCA to correlate both quantitative and textual data items is a unique feature of the present invention previously not shown in existing art methods.

Next, the CCA algorithm 20 outputs two transformation matrices, Wₜ at step 22 and W_{q} at step 24, with Wₜ being a transformation matrix for the textual data and W_{q} being a transformation matrix for the quantitative data.

FIG. 2 illustrates a method 30 used to obtain a specific item's projection coordinates 46 in its lower dimensional representation by combining textual and quantitative data with the transformation matrices Wₜ at step 22 and W_{q} at step 24 via the method of FIG. 1.

The instance textual data 32 and instance quantitative data 38 are input into transformation matrices 22 and 24 (Wₜ and W_{q}). The instance textual data 32 is first extracted at quantification step 34 to generate the quantified textual data 36 that is input to textual transformation matrix (Wₜ) 22.

At step 44, the textual and quantitative data within the transformation matrices (Wₜ and W_{q}) are combined. In one preferred embodiment, the step 44 takes the dot product between the n-dimensional vectors and the rows of their corresponding transformation matrices (e.g. the dot product of an n-dimensional vector of features with the rows of Wₜ), with each row corresponding to a dimension in the lower dimensional representation.

For example, if the desired lower dimensional representation is 2-dimensional, the dot product of an n-dimensional feature vector with the first row of Wₜ yields the first dimension of the item's position determined by their textual data and the dot product of the same feature vector with the second row of Wₜ yields the second dimension of the item's position determined by their textual data.

After the dot products are taken, the method 30 has two sets of coordinates for the lower dimensional representation for the item: one calculated by the combination of the textual data and Wₜ, and the other calculated by the combination of the quantitative data and W_{q}.

At step 44, Wₜ and W_{q} are combined through a weighted average to obtain the item's final position (projection coordinates 46) in its lower-dimensional representation (e.g. 2-D coordinate for visualization). It is understood that the higher dimensional space may comprise any number of features (e.g. thousands), and thus comprise thousands of dimensions. For example, the data items being extracted may comprise a book, with specific features comprising the authors, topics discussed, genre, date written, etc.

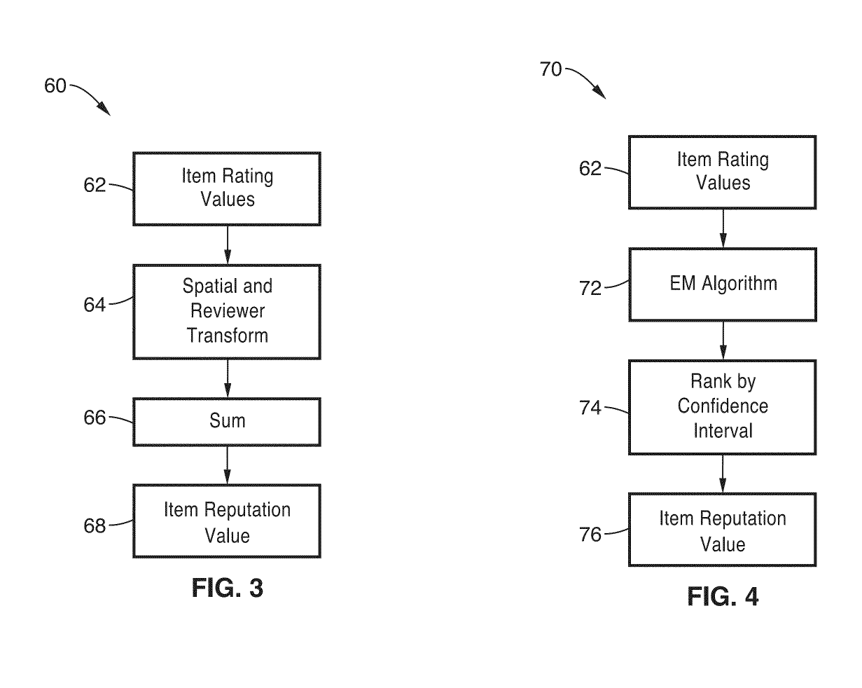

FIGS. 3 through 5 illustrate various methods for generating an item reputation vale from a set of item rating values in accordance with the present invention.

FIG. 3 shows a schematic diagram of method 60 employing spatial and reviewer reputation models that translate an item's rating values 62 into a numerical reputation value 68.

The item rating values 62 may comprise Wₜ and W_{q} obtained from methods 10 or 30 shown in FIGS. 1 and 2, or may be values acquired by other means.

In this embodiment, an item's numerical reputation value 68 can be calculated using a spatial reputation model 64 that factors in the spatial distance between the end-user who is rating an item and the item being rated. This model can also take into account the end-user's reviewer reputation.

The spatial portion of the reputation model 64 uses the following transformation for rating values: when user i gives the item j a positive rating, the system scales that rating based on how far i is from j in the space. That is, in a preferred embodiment where items are end-users, if two end-users disagree on some ratings and are further apart in the space, the fact that one end-user rates a second end-user highly is more significant. Conversely, if i gives j a negative rating, it is given greater weight the closer i is to j in the space.

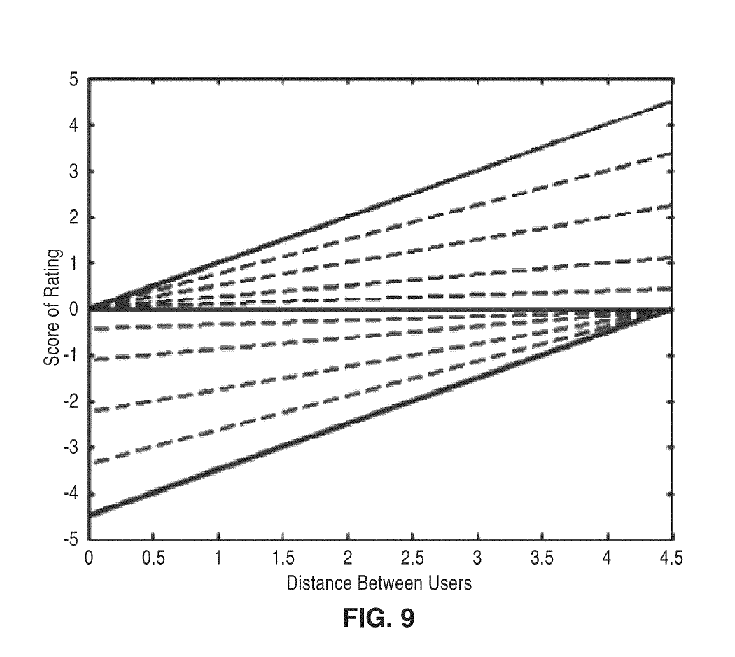

The diagram of FIG. 9 visually describes the transformation function 64. The lines below the mid-line correspond to negative ratings values and the lines above the mid-line correspond to positive ratings values. The y-axis yields the scaled rating after transformation as a function of the distance between users (x-axis).

The reviewer portion of the reputation model 64 uses the following transformation for rating values: each user builds a reputation as a reviewer in the system based for example on the number of ratings they assign to items and how well those ratings match the overall ratings by the community. Intuitively, the better the reviewer reputation of a user, the more influence the user's ratings should have on the overall rank of an item.

Each rating an end-user gives is transformed using Equation 1 below.

$${r}_{ij}^{′} = \{ \begin{matrix}{e}^{- {Z}_{i}} {r}_{ij} {d}_{ij} & if {r}_{ij} >= 0 \\ {e}^{- {Z}_{i}} \vert {r}_{ij} \vert ( {d}_{ij} {d}_{max} ) & otherwise\end{matrix} \qquad Eq . 1$$

The variables are defined as follows:

(i) rᵢⱼ is the numerical rating end-user i gave to the item j.

In a preferred embodiment, this number is limited to the continuous range between −1 and 1. rᵢⱼ′ is the transformed raw rating.

(ii) xᵢ is the numerical vector that determines the spatial location of user i. In a preferred embodiment, this numerical vector of ratings can be part of the quantitative data 18 used in the CCA projection 20 of FIG. 1.

(iii) dᵢⱼ=∥xᵢ−xⱼ∥ is the Euclidean distance between user i and item j. dₘₐₓ is assigned to be the greatest possible Euclidean distance between any two items within the system.

(iv) Zᵢ is the user i's reputation as a reviewer.

The reviewer reputation can be modeled through one or more different equations as described in Equation 2 below:

$${Z}_{i} = \{ \begin{matrix}\frac{1}{n} {\sum }_{j = 1}^{n} \vert {r}_{ij} - {μ}_{j} \vert & Mean Absolute Error \\ \frac{1}{n} {\sum }_{j = 1}^{n} {log}_{10} \vert {r}_{ij} - {μ}_{j} \vert & Log Mean Absolute Error \\ \frac{1}{n} {\sum }_{j = 1}^{n} \frac{\vert {r}_{ij} - {μ}_{j} \vert}{{σ}_{j}} & Absolute Standard Normal \\ \frac{1}{n} {\sum }_{j = 1}^{n} {log}_{10} \frac{\vert {r}_{ij} - {μ}_{j} \vert}{{σ}_{j}} & Log Absolute Standard Normal \\ {\sum }_{j = 1}^{n} \sqrt{\frac{{( {r}_{ij} - {μ}_{j} )}^{2}}{n}} & Root Mean Squared Error \\ U ( 0 , 1 ) & Uniform Random Number\end{matrix} \qquad Eq . 2$$

where n is the number of items rated by user i, rᵢⱼ is the user i's rating of item j, and p and μⱼ and σ are the mean rating and standard deviation for item j.

At step 66, items are ranked according to their weighted-in degree, defined as the normalized sum of the transformed ratings. Specifically, the reputation Cⱼ of the item j is determined by Equation 3:

$${C}_{j} = \frac{1}{{c}_{max}} {\sum }_{i} {r}_{ij}^{′} \qquad Eq . 3$$

where cₘₐₓ is the greatest magnitude sum of transformed ratings for a single item.

FIG. 4 shows a schematic diagram of method 70 employing a confidence interval reputation model that translates an item's rating values 62 via an EM algorithm 72 and confidence interval ranking step 74 to generate a numerical reputation value 76.

The confidence interval reputation model calculates the reputation of an item as the lower bound of a 95% confidence interval around the mean of a set of rating values.

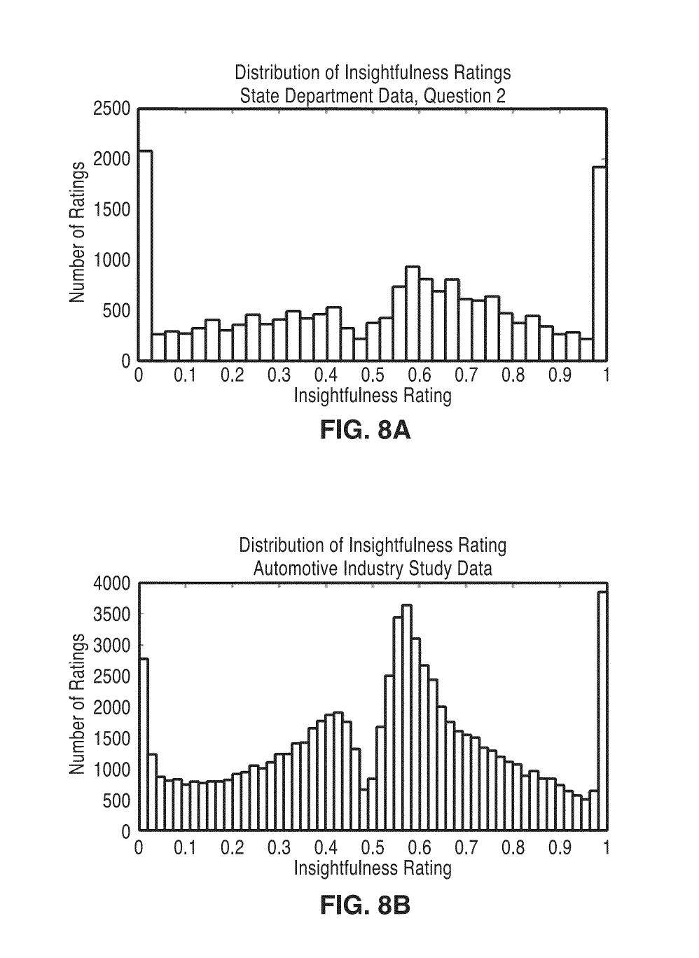

Referring to FIGS. 8A and 8B, the distribution of ratings in the system may not be well-described with a normal distribution. In a preferred embodiment, the distribution can be multi-modal and can be modeled by a mixture of normal distributions and Bernoulli distributions.

For the confidence interval reputation model, to parametrically model the distribution of ratings to find the lower bound of a 95% confidence interval, the random variable X can be, in a preferred embodiment, defined according to a spike at 0 with probability p₁, a spike at 1 with probability p₂, and a mixture of two Normal variables X₃˜N(μ₃,σ₃) and X₄˜N(μ₃,σ₄), with probabilities p₃ and p₄, respectively. The maximum likelihood estimates for p₁ and p₂ and the random variable X can be defined in Equations 4-6 as detailed below:

$$\begin{matrix} {p}_{1} = \frac{\# of ratings for X with a value of 0}{Total \# of ratings for X} & Eq . 4 \\ {p}_{2} = \frac{\# of ratings for X with a value of 1}{Total \# of ratings for X} & Eq . 5 \\ X = I ( 0 , {p}_{1} ) \times 0 + I ( {p}_{1} , {p}_{1} + {p}_{2} ) \times 1 + I ( {p}_{1} + {p}_{2} , {p}_{1} + {p}_{2} + {p}_{3} ) \times {X}_{3} + I ( {p}_{1} + {p}_{2} + {p}_{3} , 1 ) \times {X}_{4} & Eq . 6\end{matrix}$$

where I ( ) is an indicator variable corresponding to the event that the rating falls within the corresponding “bin” (was generated by the corresponding random variable).

E(X) and Var(X) are derived in Eq. 7 below:

$$\begin{matrix}E ( X ) = E ( \begin{matrix}\begin{matrix}I ( 0 , {p}_{1} ) \times 0 + I ( {p}_{1} , {p}_{1} + {p}_{2} ) \times 1 + \\ I ( {p}_{1} + {p}_{2} , {p}_{1} + {p}_{2} + {p}_{3} ) \times {X}_{3} +\end{matrix} \\ I ( {p}_{1} + {p}_{2} + {p}_{3} , 1 ) \times {X}_{4}\end{matrix} ) \\ = {p}_{1} E ( 0 ) + {p}_{2} E ( 1 ) + {p}_{3} E ( {X}_{3} ) + {p}_{4} E ( {X}_{4} ) \\ = {p}_{2} + {p}_{3} {μ}_{3} + {p}_{4} {μ}_{4}\end{matrix} \qquad Eq . 7$$

Conditioned on a rating not belonging to either the “0” or “1” bins, λ is assigned to be the probability that the rating was generated by N(μ₃,σ₃). Then the mixing probabilities for X₃ and X₄ are given by Equations 8 and 9:

p₃=λ(1−(p₁+p₂)) Eq. 8

p₄=(1−λ)(1−(p₁+p₂)) Eq. 9

Letting μ=p₂+p₃μ₃+p₄μ₄, the variance of X, σ²_{X} is then calculated according to Equation 10:

$$\begin{matrix}{σ}_{X}^{2} = \sum {p}_{i} {E ( {X}_{i} - E ( X ) )}^{2} \\ = {{p}_{1} ( 0 - μ )}^{2} + {p}_{2} ( 1 - {μ}^{2} ) + {p}_{3} {E ( {X}_{3} - μ )}^{2} + p 4 {E ( {X}_{4} - μ )}^{2} \\ = {p}_{1} {μ}^{2} + {p}_{2} ( 1 - {μ}^{2} ) + {p}_{3} E ( {X}_{3}^{2} ) + {p}_{3} E ( - 2 {X}_{3} μ + {μ}^{2} ) + \\ {p}_{4} E ( {X}_{4}^{2} ) + {p}_{4} E ( - 2 {X}_{4} μ + {μ}^{2} ) \\ = {p}_{1} {μ}^{2} + {p}_{2} ( 1 - {μ}^{2} ) + {p}_{3} ( {σ}_{3}^{2} + {μ}_{3}^{2} ) + {p}_{3} E ( - 2 {X}_{3} μ + {μ}^{2} ) + \\ {p}_{4} ( {σ}_{4}^{2} + {μ}_{4}^{2} ) + {p}_{4} E ( - 2 {X}_{4} μ + {μ}^{2} ) \\ = {p}_{1} {μ}^{2} + {p}_{2} ( 1 - {μ}^{2} ) + {p}_{3} {σ}_{3}^{2} + {p}_{3} E ( {μ}_{3}^{2} - 2 {X}_{3} μ + {μ}^{2} ) + \\ {p}_{4} {σ}_{4}^{2} + {p}_{4} E ( {μ}_{4}^{2} - 2 {X}_{4} μ + {μ}^{2} ) \\ = {p}_{1} {μ}^{2} + {p}_{2} ( 1 - {μ}^{2} ) + {p}_{3} {σ}_{3}^{2} + {p}_{3} {E ( {μ}_{3} - μ )}^{2} + {p}_{4} {σ}_{4}^{2} + \\ {p}_{4} {E ( {μ}_{4} - μ )}^{2} \\ = {p}_{1} {μ}^{2} + {p}_{2} ( 1 - {μ}^{2} ) + {p}_{3} {σ}_{3}^{2} + {{p}_{3} ( {μ}_{3} - μ )}^{2} + {p}_{4} {σ}_{4}^{2} + \\ {{p}_{4} ( {μ}_{4} - μ )}^{2}\end{matrix} \qquad Eq . 10$$

The Standard Error is computed by Equation 11:

$${SE}_{X} = \sqrt{\frac{{σ}_{X}^{2}}{n}} \qquad Eq . 11$$

Accordingly, the reputation of an item is found by calculating the lower bound of the 95 percent confidence interval around the item's mean rating as follows in Equation 12:

reputation= X̅−1.96×SE_{X} Eq. 12

Computing the variance estimate of X according to Equation 12 above necessitates empirical estimates of λ (to find p₃ and p₄), μ₃, σ₃², μ₄, and σ₄². To make these estimates, method 30 preferably uses Expectation-Maximization (EM) step 72 that implements Algorithms 1, 2, and 3 summarized below. The EM step 72 uses the estimated values to iteratively find p₃ and p₄.

Algorithm 1. The Expectation (E) Step:

Set r={r₁, . . . ,rₙ} as the set of ratings for the current item, excluding those with values of 0 or 1.

E Step (λ, μ₃, σ₃², μ₄, σ₄²):

| | |
|---|---|
| 1. | n = number of ratings |
| 2. | I = {I₁, . . . , Iₙ} |
| 3. | for i = 1, . . . , n: |
| 4. | p₃ ← λf(rᵢ \| μ₃, σ₃) |
| 5. | p₄ ← (1 − λ)f(rᵢ \| μ₄, σ₄) |
| 6. | ${I}_{i} ← \frac{{p}_{3}}{{p}_{3} + {p}_{4}}$ |
| 7. | return I |

Algorithm 2. The Maximization (M) Step:

Set r={r₁, . . . ,rₙ} as the set of ratings for the current item, excluding those with values of 0 or 1. I={I₁, . . . ,Iₙ} indicates the probability that the rating was generated by N(μ₃,σ₃) instead of N(μ₄,σ₄).

M Step (I, r):

| | |
|---|---|
| 1. | $λ ← \frac{{\sum }_{i}^{ } {I}_{i}}{n}$ |
| 2. | ${µ}_{3} ← \frac{{\sum }_{i}^{ } {I}_{i} {r}_{i}}{{\sum }_{i}^{ } {I}_{i}}$ |
| 3. | ${σ}_{3}^{2} ← \frac{{\sum }_{i}^{ } {{I}_{i} ( {r}_{i} - {µ}_{3} )}^{2}}{{\sum }_{i}^{ } {I}_{i}}$ |
| 4. | ${µ}_{4} ← \frac{{\sum }_{i}^{ } ( 1 - {I}_{i} ) {r}_{i}}{{\sum }_{i}^{ } ( 1 - {I}_{i} )}$ |
| 5. | ${σ}_{4}^{2} ← \frac{{\sum }_{i}^{ } ( 1 - {I}_{i} ) {( {r}_{i} - {µ}_{4} )}^{2}}{{\sum }_{i}^{ } ( 1 - {I}_{i} )}$ |
| 6. | return λ, μ₃, σ₃², μ₄, σ₄² |

Algorithm 3. Running the Iterations of the EM Algorithm

Parameters are initialized to some reasonable estimated value.

EM(λ,μ₃,σ₃²,μ₄,σ₄²) :

1. 1 = number of iterations
2. for i = 1,..., 1:
3. I ← EStep(λ,μ₃,σ₃²,μ₄,σ₄²)
4. (λ,μ₃,σ₃²,μ₄,σ₄²) ← MStep(I)
5. return λ, μ₃, σ₃², μ₄, σ₄²

Before executing the algorithms for EM step 72, the method 70 pre-processes the ratings data 62 by removing all 0- and 1-valued ratings, which enables us to focus on finding parameters to describe the ratings in the open interval (0, 1).

The Expectation (E) Step, or Algorithm 1, starts with estimates for the values of λ, μ₃, σ₃², μ₄, and σ₄². In a preferred embodiment, these variables are empirically based off of the data. As an example, referring to FIGS. 8A and 8B, μ₃ can be set to be 0.25 and μ₄ to be 0.75 as the normal distributions are centered on those values. Also, λ can be set to be 0.5 to give equal weight to either normal distribution conditioned on a rating not belonging to the “0” or “1” bins, μ₃ to be 0.25, μ₄ to be 0.75, and the variances can be set to be 0.05 to reflect the spread in the normal distributions.

End-users provide a set of ratings r={r₁, . . . ,rₙ} for an item. Here n is assigned to be the number of ratings collected for some item, and I={I₁, . . . ,Iₙ} is assigned to be a set of n variables, where Iⱼ corresponds to the probability that rating rⱼ was generated by N(μ₃,σ₃) instead of N(μ₄,σ₄). Recall that λ is the probability that a randomly sampled rating is generated by the left-most Normal distribution, N(μ₃,σ₃). f(x|μ,σ) is assigned to be the probability density function of the Normal distribution with mean μ and standard deviation σ.

For each rating rᵢ collected for this item, p₃ is computed as the marginal probability that rᵢ was generated by N(μ₃,σ₃) and p₄ is computed as the marginal probability that rᵢ was generated by N(μ₄,σ₄). Given these values, the probability that rᵢ was generated by N(μ₃,σ₃) is computed in line 6 of the Expectation step (Algorithm 1) and assigned to Iᵢ. Once computed for each rating, the set of indicator probabilities are passed to the Maximization (M) step (Algorithm 2), along with the original rating values.

The M Step (Algorithm 2) uses I to update our estimates for all of the parameters used to describe our statistical model. Hence, λ is computed as the average of the values of {I₁, . . . , Iₙ}. The mean μ₃ of the left-most Normal distribution is the average value of the ratings weighted by I. Similarly the mean μ₄ of the right-most Normal distribution is the average values of the ratings weighted by (1−I). The estimates for the variances also follow the standard formula, weighted by I.

Referring to Algorithm 3, to run the EM algorithm, the values for λ, μ₃, σ₃², μ₄, and σ₄² are first initialized. The EM algorithm is run until it converges. In a preferred embodiment, the algorithm can be run for up to 1000 iterations.

As shown in FIGS. 3 and 4, the spatial and reviewer reputation models 60 and 70 can each individually and independently transform and combine an item's ratings 62 to output a reputation 68 or 76.

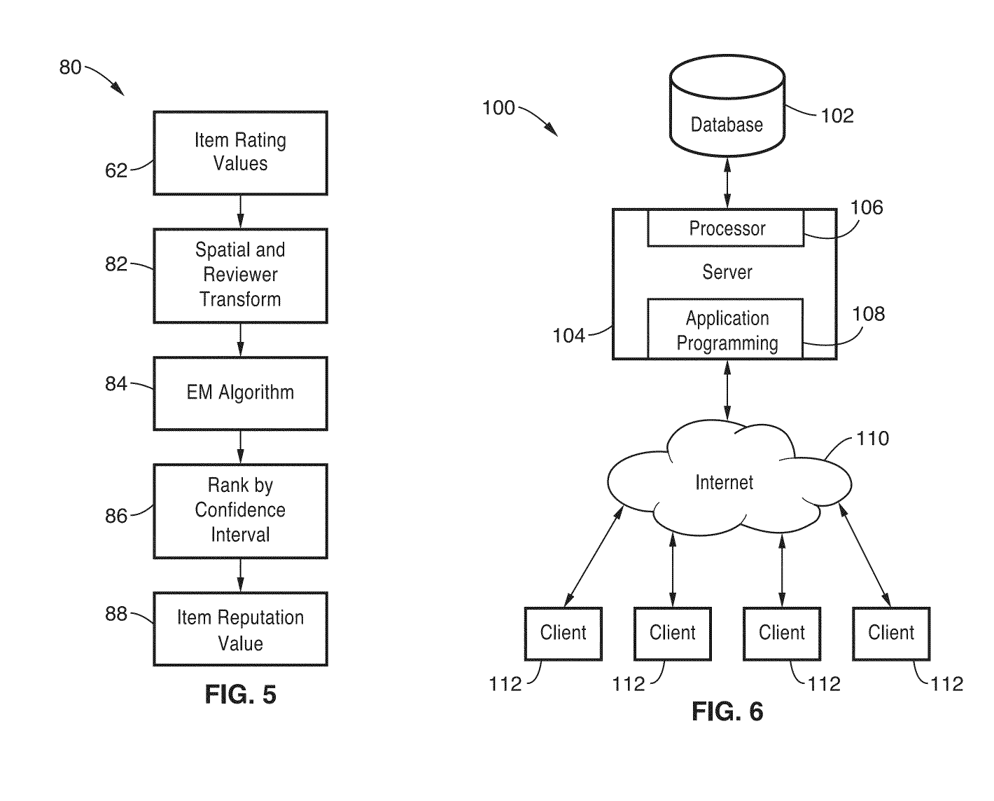

In another preferred embodiment shown in FIG. 5, a method 80 generates an item reputation value 88 from item rating values 62 by incorporating a confidence interval metric (EM algorithm 84 and confidence interval ranking step 86) used in combination with the spatial and reviewer reputation model (transform 82). In this embodiment, items are ranked by the lower bound of the 95% confidence interval of the mean ratings for that item, where the ratings are ratings that have been transformed by the transformation functions described in the spatial and reviewer reputation models above.

In one embodiment, one or more of the methods 10, 30, 60, 70 and 80 may be configured to actively solicit ratings on low confidence items using probabilistic sampling. Each item is given a weight based on a function of the number of ratings the item has received, a measure of confidence of the ratings the item has received, and the time that has elapsed since the item was created. In a preferred embodiment, a measure of confidence is the standard error of the mean of all the ratings for a particular item. Items with higher weight have a higher chance of being chosen in the sampling process. This process ensures that ratings are well-distributed amongst the items in the system and also acts as a security measure against malicious end-users that may want to rate up one specific item in the system.

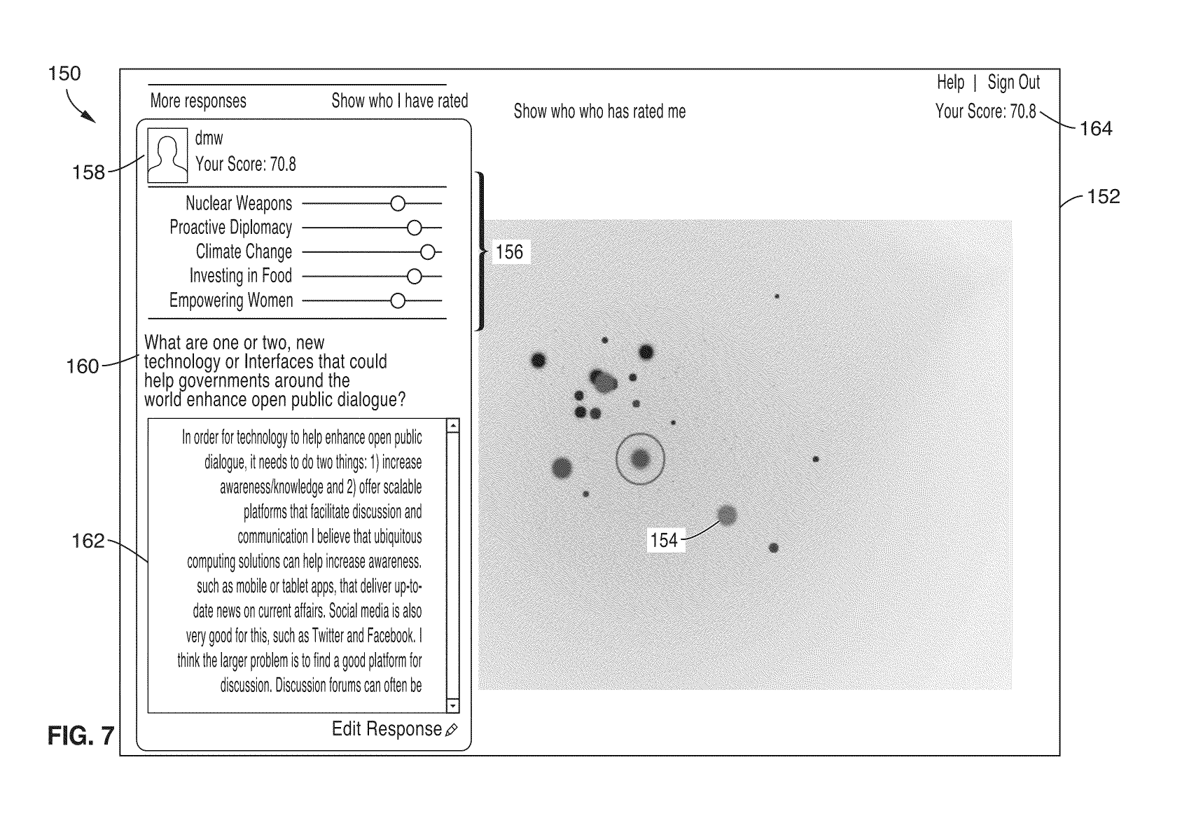

FIG. 6 shows a schematic view of a system 100 in accordance with the present invention having a server 104 in communication with a database 102 and with clients or client devices 112 through the Internet 110. The server 104 comprises a processor 106 and application programming 108 comprising code executable on processor 106 for carrying out one or more of methods 10, 30, 60, 70, and 80 shown above in FIGS. 1-5, and optionally the graphical user interface/visualization system 150 illustrated in FIGS. 7, 10 and 11.

A preferred embodiment of the present invention can involve server 104 to client 112 communication over the Internet 110. An exemplary server 104 may comprise a 2-core 2 GHz machine and the client 112 may comprise an Internet browser application running on top of a 1 GHz PC laptop.

FIG. 7 is an illustration of a preferred embodiment of the invention having a graphical user interface that serves as an interactive visualization system 150 to output the lower dimensional representation (e.g. 2-D representation) derived from application of one or more of methods 10, 30, 60, 70, and 80 detailed in FIGS. 1-5 above. This interactive visualization 150 (e.g. graphical “map”) may be used to display a multitude of “items” or “data items” in an online environment based on textual and quantitative (rating) properties of those items to facilitate the browsing and rating of those items. In one embodiment, the interactive visualization 150 is integral with or comprise a module within the application programming 108 used in the system 100 of FIG. 6. It is appreciated that the methods embodied in FIGS. 1-5 and system 100 shown in FIG. 6, however, do not need to use an interactive visualization to facilitate the browsing and rating of items output by any of the methods above.

Visualization 150 may comprise an interactive screen 152 for visualizing a two dimensional space where individual data items 154 are represented spatially with respect to each-other. Visualization system 150 may also be individually loaded at the client 112, or be launched from remote server 104 for viewing by individual client devices 112.

Interactive screen 152 may comprise indicia for identifying the current user 158 and user core 164. The interactive screen 152 may also comprise one or more visual analog scales 156 for generating a rating value with respect to certain topics or users. As shown in FIG. 7, a user may comment on a topic 160 by generating text in a form 162, which may be uploaded to server 104 and database 102 for later extraction.

“Data items” may be quantified data relating to subjects such as a topic of interest, or end-users 158 themselves may comprise the data items in the system 100 or visualization 150. End users 158 may use graphical sliders 156 to express the degree to which they agree or disagree with one or more (e.g. five) baseline statements such as: “I'm very interested in issue A,” or “I am an active user of product B.” These responses are combined to display the end-user 158 as a unique point in a map. The visualization or map 152 is not based on predetermined categories, but on similarity of interests, behavior, and perspectives. The map 152 is configured to “depolarize” discussions by including all end-users 158 on a single level playing field. End-users 158 may click on the points of other users to read ideas and suggestions on discussion topics such as “What new approaches could be used to address issue C?” or “What features would you like to see in a new version of product D?” End users 158 may evaluate the ideas of others and enter their own ideas. End users 158 may also earn points as reviewers based on how they evaluate the ideas of others and earn points as authors based on how others rate their ideas.

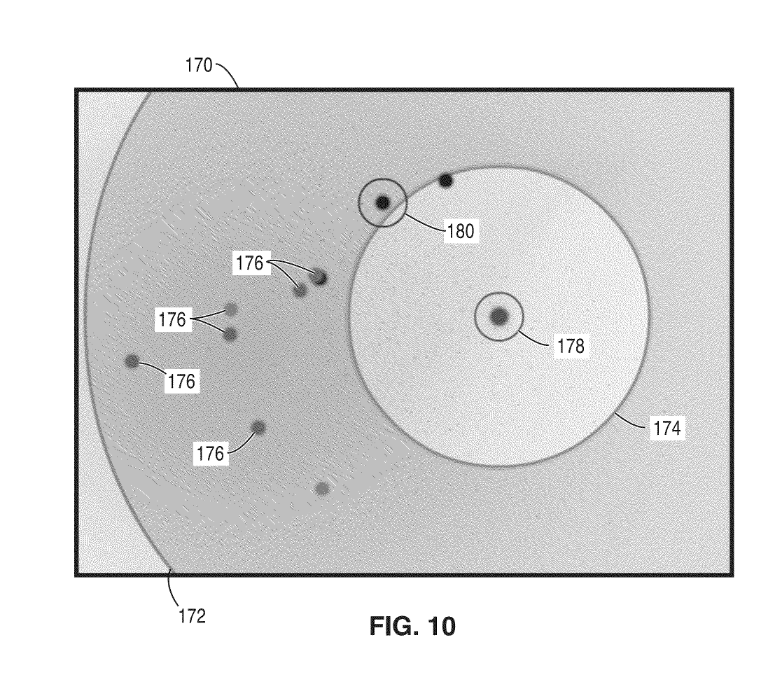

FIG. 10 illustrates a selection screen 170 for defining a search region for data items of interest. Selection screen 170 comprises two concentric user-defined circles 172 and 174 centered around the user's point 178 to allow for a user to control the search for recommended items within the interactive system 150.

The area between the two concentric circles 172 and 174 defines the spatial region that is queried for items of interest (e.g. points 176 and closes point 180 within the selection region). The user can adjust the radius of the inner 174 or outer circle 172 by clicking and dragging on the circle's edge.

After the user defines the region, an underlying recommendation system retrieves items 176, 180 whose coordinates fall within that region.

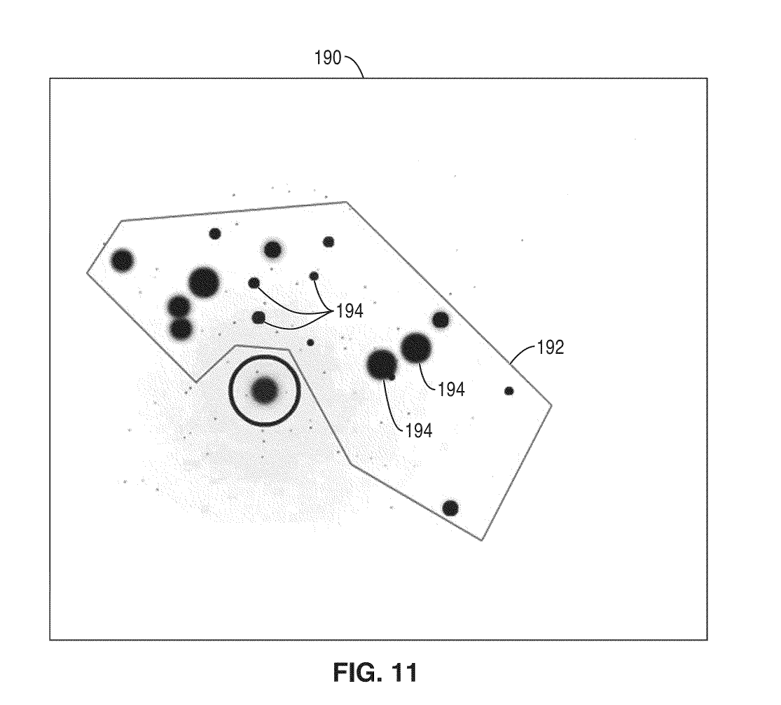

FIG. 11 illustrates a selection screen 190 having lasso tool 192 that can create free-form, circular, and polygonal search regions that are not centered around the user's point. As seen in FIG. 11 the user had indicated the search region by drawing a polygonal search area 192. With this implementation, the user can draw a search region at any point in the space. The user can choose to draw the search region 192 using the free-form tool, much like the pencil or paintbrush function in drawing applications, the circle tool, which draws a circle or ellipse with the size of the circle determined by the distance the mouse is dragged, and the line tool, which a user can use to draw polygons, requiring only that the lines form a closed shape. After the user defines the region 192, the system 150 retrieves items 194 whose coordinates fall within that region.

In another embodiment, the visualization system 150 can also display item points color coded based for example on demographic data, for example system 150 could color points based on age, gender, or income level. Visualization system 150 could also be used to selectively display points that have or do not have certain features.

The visualization system 150 can also include other display features such as highlighting all points corresponding to those who have rated a particular item or all items that have been rated by a particular end-user.

In one embodiment, security measures may be employed for coping with “rogue” ratings. The system 100 may include a classifier that measures the time it takes an end-user or client 112 to rate an item compared to the time it took every other end-user to rate the same item, the session durations of the end-user, the rating value the end-user gave the item compared to the rating values other end-users gave the same item, and the session activity of the end-user. Using these features, an alternative embodiment of the system 100 uses these techniques to eliminate ratings that may not have been thoughtfully determined.

The system 100 may also include integration with a social networking application, such as Facebook, other social media, or integrated with other social media systems. In one embodiment, the system 100 is configured to import end-user account information from a system such as Facebook or Twitter.

Embodiments of the present invention may be described with reference to equations, algorithms, and/or flowchart illustrations of methods according to embodiments of the invention. These methods may be implemented using computer program instructions executable on a computer. These methods may also be implemented as computer program products either separately, or as a component of an apparatus or system. In this regard, each equation, algorithm, or block or step of a flowchart, and combinations thereof, may be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the equation (s), algorithm(s), and/or flowchart(s).

Accordingly, the equations, algorithms, and/or flowcharts support combinations of means for performing the specified functions, combinations of steps for performing the specified functions, and computer program instructions, such as embodied in computer-readable program code logic means, for performing the specified functions. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the equation (s), algorithm(s), and/or block(s) of the flowchart(s).

From the discussion above it will be appreciated that the invention encompasses various inventive features, including the following:

1. A system for comparative evaluation of one or more items of data received between a plurality of end users, comprising: a server computer; and programming executable on the server computer for: receiving input from one or more client computers; said input relating to the one or more items of data; wherein said input comprises quantitative data and textual data relating to the one or more data items; and applying one or more transformation functions to the textual and quantitative data to project one of the one or more data items from a first multi-dimensional representation to a second multi-dimensional representation; wherein the first multi-dimensional representation comprises at least one more dimension than the second multi-dimensional representation.

2. The system of embodiment 1: wherein the quantitative data comprises one or more ratings corresponding to the one or more data items; the one or more ratings generated by the plurality of users.

3. The system of embodiment 2, wherein the one or more ratings are generated via a visual analog scale.

4. The system of embodiment 2, wherein the textual data comprises one or more of: textual responses corresponding to discussion topics, names, addresses and meta data.

5. The system of embodiment 1, wherein said programming is further configured for: extracting one or more features from said textual data; and transforming the textual data into a multi-dimensional vector of values.

6. The system of embodiment 5, wherein said programming is further configured for: combining the textual and quantitative data with one or more transformation matrices.

7. The system of embodiment 5, wherein said transforming is performed using canonical correlation analysis.

8. The system of embodiment 6, wherein combining the textual and quantitative data comprises: calculating a dot product between the multi-dimensional vectors and rows of corresponding transformation matrices with a row corresponding to a dimension in the second multi-dimensional representation.

9. The system of embodiment 1, wherein the data items comprise one or more of: discussion topics, textual responses, object names, documents, songs, videos or data relating to end users.

10. The system of embodiment 1, wherein the second multi-dimensional representation comprises a visualization of data relating to the data items in a two or three dimensional space.

11. The system of embodiment 1, wherein the visualization comprises a numerical value corresponding to a reputational feature of a data item.

12. The system of embodiment 1, wherein the visualization is configured to allow one or more end users to browse and rate data items within the visualization.

13. The system of embodiment 12, wherein said visualization comprises a user-interface configured to allow users to indicate a region within the visualization for returning data relating to one or more targeted data items.

14. The system of embodiment 1, wherein said programming is further configured for: generating a numerical reputation value based on a spatial distance corresponding to a data item being rated and an end user rating the data item.

15. The system of embodiment 14, wherein the reputation value is calculated as a function of an end user's reputation as a reviewer.

16. The system of embodiment 1, wherein the second multi-dimensional representation comprises two sets of coordinates relating to a data item.

17. The system of embodiment 14, wherein said programming is further configured for: calculating a confidence interval as a parametric function relating to a distribution of the one or more ratings.

18. A system for comparative evaluation of one or more items of data received between a plurality of end users, comprising: a server computer; and programming executable on the server computer for: receiving input from one or more client computers; said input comprising data relating to one or more rating values associated with said one or more data items and data relating to the plurality of users; assigning a location corresponding to one of the one or more data items based on the inputted rating values; assigning a location corresponding to one of the plurality of users based on the inputted data relating to the plurality of users; and generating a numerical reputation value based on a spatial distance corresponding to a data item being rated and an end user rating the data item.

19. The system of embodiment 18, wherein the reputation value is calculated as a function of an end user's reputation as a reviewer.

20. The system of embodiment 18, wherein said programming is further configured for: calculating a confidence interval as a parametric function relating to a distribution of the one or more ratings.

21. The system of embodiment 18, wherein said input comprises quantitative data and textual data relating to the one or more data items, the programming further configured for: applying one or more transformation functions to the textual and quantitative data to project one of the one or more data items from a first multi-dimensional representation to a second multi-dimensional representation; wherein the first multi-dimensional representation comprises at least one more dimension than the second multi-dimensional representation

22. The system of embodiment 21: wherein the quantitative data comprises one or more ratings corresponding to the one or more data items; the one or more ratings generated by the plurality of users.

23. The system of embodiment 22, wherein the textual data comprises one or more of: textual responses corresponding to discussion topics, names, addresses and meta data.

24. A system for comparative evaluation of one or more items of data received between a plurality of end users, comprising: a server computer; and programming executable on the server computer for: receiving input from one or more client computers; said input comprising data relating to one or more rating values associated with said one or more data items and data relating to the plurality of users; and calculating a confidence interval as a parametric function relating to a distribution of the one or more ratings.

25. The system of embodiment 24, said programming further configured for: assigning a location corresponding to one of the one or more data items based on the inputted rating values; assigning a location corresponding to one of the plurality of users based on the inputted data relating to the plurality of users; and generating a numerical reputation value based on a spatial distance corresponding to a data item being rated and an end user rating the data item.

26. The system of embodiment 25, wherein the reputation value is calculated as a function of an end user's reputation as a reviewer. 27. The system of embodiment 24, wherein the confidence interval is calculated as a function of a maximum likelihood estimate corresponding to the one or more data items.

28. The system of embodiment 27, wherein the confidence interval is calculated as a function of an expectation estimate corresponding to the one or more data items.

29. The system of embodiment 24, wherein said input comprises quantitative data and textual data relating to the one or more data items, the programming further configured for: applying one or more transformation functions to the textual and quantitative data to project one of the one or more data items from a first multi-dimensional representation to a second multi-dimensional representation; wherein the first multi-dimensional representation comprises at least one more dimension than the second multi-dimensional representation.

30. The system of embodiment 29: wherein the quantitative data comprises one or more ratings corresponding to the one or more data items; the one or more ratings generated by the plurality of users.

31. The system of embodiment 30, wherein the textual data comprises one or more of: textual responses corresponding to discussion topics, names, addresses and meta data.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A system for comparative evaluation of one or more items of data received between a plurality of end users, comprising:
a server computer; and
programming executable on the server computer for:
receiving input from one or more client computers;
said input relating to the one or more items of data;
wherein said input comprises quantitative data and textual data relating to the one or more data items; and
applying one or more transformation functions to the textual and quantitative data to project one of the one or more data items from a first multi-dimensional representation to a second multi-dimensional representation;
wherein the first multi-dimensional representation comprises at least one more dimension than the second multi-dimensional representation.

2. A system as recited in claim 1:
wherein the quantitative data comprises one or more ratings corresponding to the one or more data items;
the one or more ratings generated by the plurality of users.

3. A system as recited in claim 2, wherein the one or more ratings are generated via a visual analog scale.

4. A system as recited in claim 2, wherein the textual data comprises one or more of: textual responses corresponding to discussion topics, names, addresses and meta data.

5. A system as recited in claim 1, wherein said programming is further configured for:
extracting one or more features from said textual data; and
transforming the textual data into a multi-dimensional vector of values.

6. A system as recited in claim 5, wherein said programming is further configured for:
combining the textual and quantitative data with one or more transformation matrices.

7. A system as recited in claim 5, wherein said transforming is performed using canonical correlation analysis.

8. A system as recited in claim 6, wherein combining the textual and quantitative data comprises:
calculating a dot product between the multi-dimensional vectors and rows of corresponding transformation matrices with a row corresponding to a dimension in the second multi-dimensional representation.

9. A system as recited in claim 1, wherein the data items comprise one or more of: discussion topics, textual responses, object names, documents, songs, videos or data relating to end users.

10. A system as recited in claim 1, wherein the second multi-dimensional representation comprises a visualization of data relating to the data items in a two or three dimensional space.

11. A system as recited in claim 1, wherein the visualization comprises a numerical value corresponding to a reputational feature of a data item.

12. A system as recited in claim 1, wherein the visualization is configured to allow one or more end users to browse and rate data items within the visualization.

13. A system as recited in claim 12, wherein said visualization comprises a user-interface configured to allow users to indicate a region within the visualization for returning data relating to one or more targeted data items.

14. A system as recited in claim 2, wherein said programming is further configured for:
generating a numerical reputation value based on a spatial distance corresponding to a data item being rated and an end user rating the data item.

15. A system as recited in claim 14, wherein the reputation value is calculated as a function of an end user's reputation as a reviewer.

16. A system as recited in claim 1, wherein the second multi-dimensional representation comprises two sets of coordinates relating to a data item.

17. A system as recited in claim 14, wherein said programming is further configured for:
calculating a confidence interval as a parametric function relating to a distribution of the one or more ratings.

18. A system for comparative evaluation of one or more items of data received between a plurality of end users, comprising:
a server computer; and
programming executable on the server computer for:
receiving input from one or more client computers;
said input comprising data relating to one or more rating values associated with said one or more data items and data relating to the plurality of users;
assigning a location corresponding to one of the one or more data items based on the inputted rating values;
assigning a location corresponding to one of the plurality of users based on the inputted data relating to the plurality of users; and
generating a numerical reputation value based on a spatial distance corresponding to a data item being rated and an end user rating the data item.

19. A system as recited in claim 18, wherein the reputation value is calculated as a function of an end user's reputation as a reviewer.

20. A system as recited in claim 18, wherein said programming is further configured for:
calculating a confidence interval as a parametric function relating to a distribution of the one or more ratings.

21. A system as recited in claim 18, wherein said input comprises quantitative data and textual data relating to the one or more data items, the programming further configured for:
applying one or more transformation functions to the textual and quantitative data to project one of the one or more data items from a first multi-dimensional representation to a second multi-dimensional representation;
wherein the first multi-dimensional representation comprises at least one more dimension than the second multi-dimensional representation

22. A system as recited in claim 21:
wherein the quantitative data comprises one or more ratings corresponding to the one or more data items;
the one or more ratings generated by the plurality of users.

23. A system as recited in claim 22, wherein the textual data comprises one or more of: textual responses corresponding to discussion topics, names, addresses and meta data.

24. A system for comparative evaluation of one or more items of data received between a plurality of end users, comprising:
a server computer; and
programming executable on the server computer for:
receiving input from one or more client computers;
said input comprising data relating to one or more rating values associated with said one or more data items and data relating to the plurality of users; and
calculating a confidence interval as a parametric function relating to a distribution of the one or more ratings.

25. A system as recited in claim 24, said programming further configured for:
assigning a location corresponding to one of the one or more data items based on the inputted rating values;
assigning a location corresponding to one of the plurality of users based on the inputted data relating to the plurality of users; and
generating a numerical reputation value based on a spatial distance corresponding to a data item being rated and an end user rating the data item.

26. A system as recited in claim 25, wherein the reputation value is calculated as a function of an end user's reputation as a reviewer.

27. A system as recited in claim 24, wherein the confidence interval is calculated as a function of a maximum likelihood estimate corresponding to the one or more data items.

28. A system as recited in claim 27, wherein the confidence interval is calculated as a function of an expectation estimate corresponding to the one or more data items.

29. A system as recited in claim 24, wherein said input comprises quantitative data and textual data relating to the one or more data items, the programming further configured for:
applying one or more transformation functions to the textual and quantitative data to project one of the one or more data items from a first multi-dimensional representation to a second multi-dimensional representation;
wherein the first multi-dimensional representation comprises at least one more dimension than the second multi-dimensional representation.

30. A system as recited in claim 29:
wherein the quantitative data comprises one or more ratings corresponding to the one or more data items;
the one or more ratings generated by the plurality of users.

31. A system as recited in claim 30, wherein the textual data comprises one or more of: textual responses corresponding to discussion topics, names, addresses and meta data.
